(19) United States
(12) Patent Application Publication
(10) Pub. No.: US 2008/0179905 A1
(43) Pub. Date: Jul. 31, 2008

(54) HANDHELD GRIPPING DEVICE

(75) Inventor: MARTIN PARK, Wichita, KS (US)

Correspondence Address: SHOOK, HARDY & BACON LLP;INTELLECTUAL PROPERTY DEPARTMENT, 2555 GRAND BLVD, KANSAS CITY, MO, 64108-2613, US

(73) Assignee: MOMMY'S HELPER, INC., Wichita, KS (US)

(21) Appl. No.: 12/018,941

(22) Filed: Jan. 24, 2008

Related U.S. Application Data
(60) Provisional application No. 60/897,516, filed on Jan. 25, 2007.

(51) Int. Cl. A47J 45/00

(52) U.S. Cl. 294/64.1

(57) ABSTRACT

A handheld gripping device provides a user with a point of stability in maneuvering in various indoor situations. In one aspect, the device includes a handle portion, a base from which the handle portion extends, one or more suction elements positioned relative to the base, and a cam driven mechanism coupled with each suction element and with the base. The cam driven mechanism selectively draws the respective suction element towards and away from the base.

### CROSS-REFERENCE TO RELATED APPLICATIONS

This application claims priority to commonly owned U.S. provisional application Ser. No. 60/897,516, filed Jan. 25, 2007, incorporated by reference herein.

### STATEMENT REGARDING FEDERALLY SPONSORED RESEARCH OR DEVELOPMENT

None.

### BACKGROUND

There has been a need to provide persons with increased stability in performing certain indoor activities, such as stepping into and out of a bathtub or shower unit, or otherwise moving between a seated and a standing position. This is of particular importance in bathrooms where flooring oftentimes presents a smooth surface that becomes quite slippery when wet.

One well known solution is to provide a handle-type device, typically secured to a wall with screws or other fasteners. Handles of these types have drawbacks. For instance, not all surfaces where it is desired to place the handle are well adapted to receive fasteners, such as the side ledge of a bathtub. Cast iron, fiberglass, and certain other materials frequently utilized in bathtub construction oftentimes do not receive fasteners well. In some cases, it can be difficult to drill a hole through the material where the fastener is to extend, or otherwise the material is sufficiently brittle that the integrity of the hole through which the fastener extends significantly degrades over time.

### BRIEF SUMMARY

Various embodiments of a repositionable, handheld gripping device disclosed herein provides a user with a point of stability in maneuvering in various indoor situations.

In one aspect, a repositionable, handheld gripping device includes a handle portion, a base from which the handle portion extends, one or more suction elements positioned relative to the base, and a cam driven mechanism coupled with each suction element and with the base. The cam driven mechanism selectively draws the respective suction element towards and away from the base.

In another aspect, a repositionable, handheld gripping device includes a handle portion, a pair of downwardly oriented end supports disposed at opposite sides of the handle, a pair of suction elements, and a pair of cam driven mechanisms. Each cam driven mechanism is coupled with one of the end supports and connected to one of the suction elements, such that movement of the respective cam driven mechanism selectively draws the respective suction element towards and away from one of the end supports.

### BRIEF DESCRIPTION OF THE DRAWINGS

In the accompanying drawings which form a part of the specification and are to be read in conjunction therewith, and in which like reference numerals are used to indicate like parts in the various views:

FIG. 1A is a perspective view of a repositionable, handheld gripping device in the disengaged position, in accordance with an embodiment of the present invention;

FIG. 1B is a perspective view of a repositionable, handheld gripping device in the engaged position, in accordance with an embodiment of the present invention;

FIG. 2A is a perspective sectional view of gripping device of FIG. 1A, taken in the longitudinal direction, in accordance with an embodiment of the present invention;

FIG. 2B is a perspective sectional view of gripping device of FIG. 1B, taken in the longitudinal direction, in accordance with an embodiment of the present invention;

FIG. 3A is an enlarged elevational view of one of the end supports of the gripping device of FIG. 2A, in accordance with an embodiment of the present invention; and

FIG. 3B is an enlarged elevational view of one of the end supports of the gripping device of FIG. 2B, in accordance with an embodiment of the present invention.

### DETAILED DESCRIPTION

A repositionable, handheld gripping device provides a user with a point of stability in maneuvering in various indoor situations. The device employs one or more suction elements that are freely engaged and disengaged by a respective levered cam element, enabling easy repositioning of the gripping device to a desired location. For instance, a user may desire to have the gripping device placed on the horizontal ledge of a bathtub when stepping into and out of the bathtub, so that their hand on the device provides a contact point of stabilization in addition to their feet. As another example, the gripping device could be placed upon smooth, hard vertical surface adjacent to a bathtub or within or adjacent to a shower unit, such as a tile or fiberglass wall. In such a case, the gripping device again enables the user's gripping hand to serve as an additional contact point of stabilization. The gripping device is particularly well suited for use as a lateral stabilization point, as opposed to acting as a true pull or lift handle where the user's hand would place a significant portion of the user's weight on the handle. In any case, the strength of the bond between the device of the present invention and the surface upon which it is placed relates to the adhesion vacuum between the one or more suction elements and the surface being engaged.

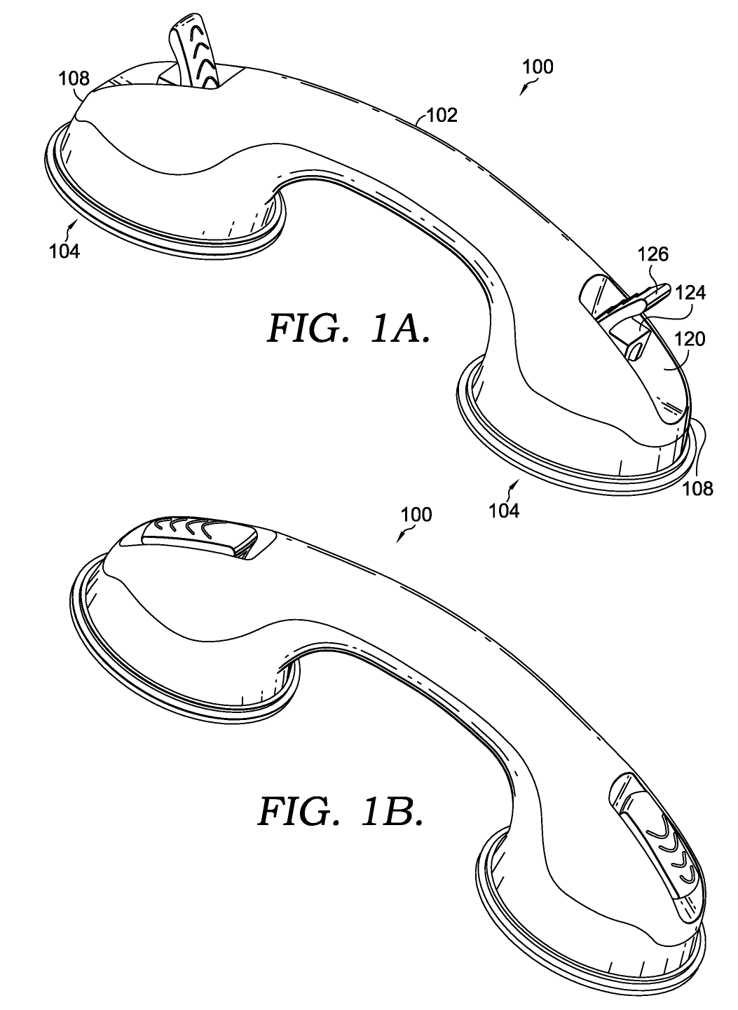

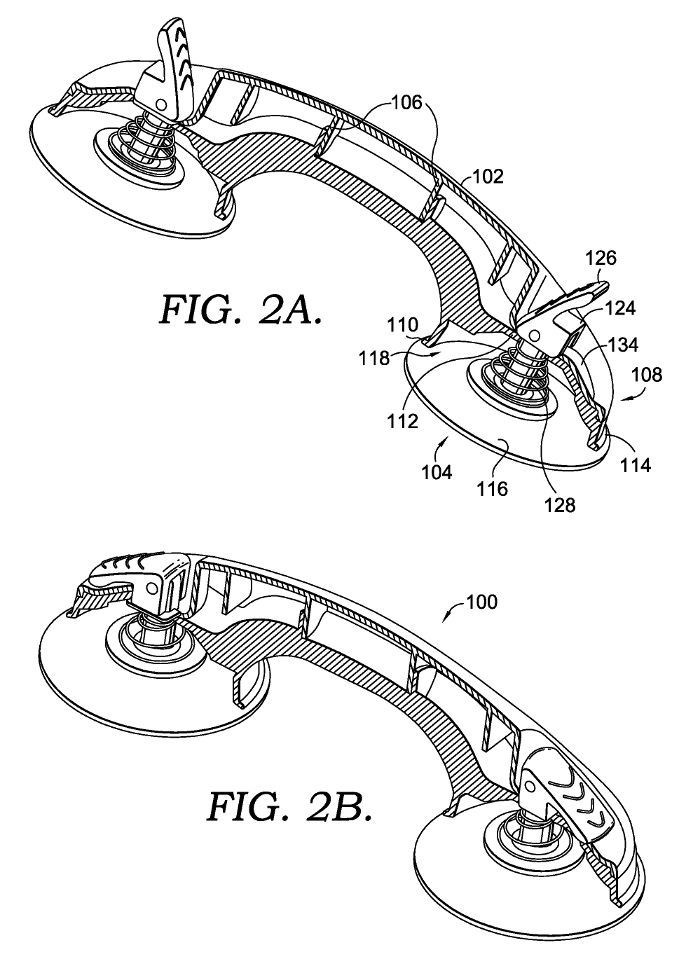

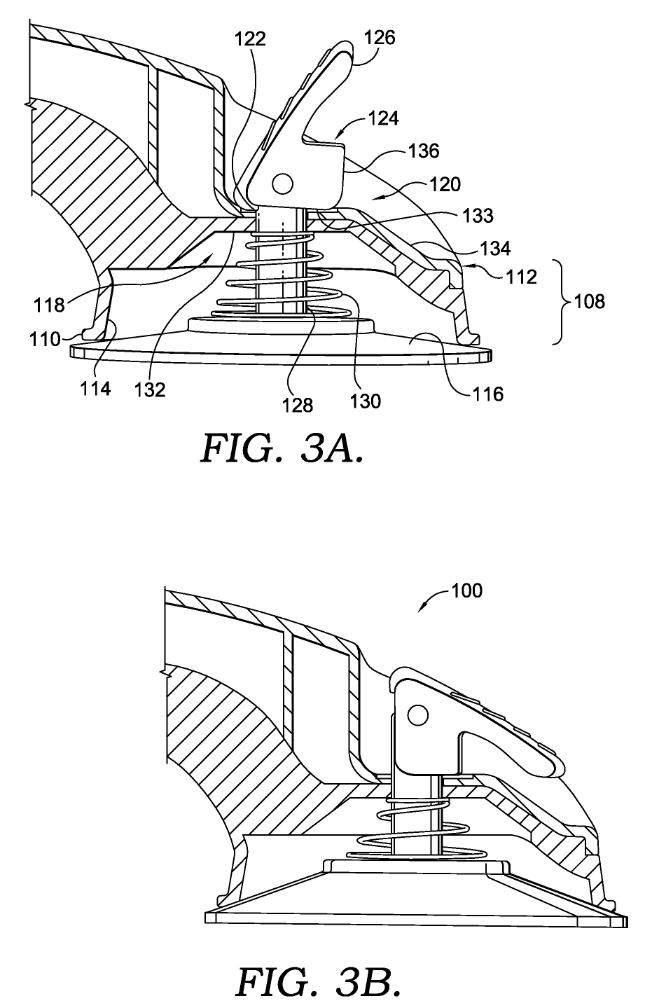

Turning to FIGS. 1A-3B, one embodiment of the handheld gripping device 100 is depicted. The gripping device 100 has a generally arcuately shaped central handle portion 102 and a set of end mounted gripping mechanisms 104. The central handle portion 102 is generally formed out of a molded plastic frame presenting a hollow design strengthened by a series of parallel ribs 106, as shown in FIGS. 2A and 2B. The molded plastic frame extends longitudinally from the central handle portion 102 to form opposed cylindrical and downwardly oriented end supports 108 that coordinate to serve as a base for the device 100. Each end support 108 guides the motion of the end mounted gripping mechanisms 104 for engagement and disengagement with a surface contacted by the gripping mechanisms 104. Specifically, each end support 108 has an open end portion 110, an upper portion 112, and a cylindrical body wall 114 extending between the open end portion 110 and the upper portion 112, as seen in FIGS. 2A-3B. The open end portion 110 serves to contact an individual suction cup 116 of one of the gripping mechanisms 104 when the gripping device 100 is moved to the engaged position, to aid in maintaining the vacuum between the suction cup 116 and the engaged surface. An interior region 118 of the end support 108 is defined by the cylindrical body wall 114, while the upper portion 112 is formed with a recessed area 120 and a passageway 122 extending between the end support interior region 118 and the recessed area 120.

The end mounted gripping mechanisms 104 each include a cam body 124, a lever 126 extending from the cam body 124, as well as a driving rod 128 pinned on one end with the cam body 124 and connected with the suction cup 116 on an opposite end. In this arrangement, the driving rod 128 extends through the interior region 118 of the end support 108 and through the passageway 122, to locate the cam body 124 within the recessed area 120. Additionally, a compression spring 130 is seated around the driving rod 128 within the end support interior region 118. The compression spring 130 contacts a ceiling 132 of the end support interior region 118 on one axial end, and the suction cup 116 on the opposed axial end of the spring 130, as best seen in FIG. 3A.

In this disengaged position of the gripping device 100, shown in FIGS. 1A, 2A and 3A, the lever 126 extends upwardly out of the recessed area 120 of the end support 108 while a first surface 133 of the cam body 124 contacts a floor 134 of the recessed area 120. Additionally, the compression spring 130 urges the corresponding end support 108 upwardly and away from the suction cup 116. Upon the user pressing the gripping device 100 against a surface, so that the suction cups 116 adhere to the surface by trapping air between the bottom of the cups 116 and the respective surface, the user may “lock” or fully engage the device 100 with the surface, as will be explained with reference to FIGS. 1B, 2B and 3B.

Turning now to FIGS. 1B, 2B and 3B, the user can then rotate each cam body 124 by moving the levers 126 downwardly into the recessed areas 120. The cam body 124 rotates so that a second surface 136 of the body 124 comes into contact with the recessed area floor 134, thereby causing the driving rod 128 to slide upwardly through the passageway 122 and the spring 130 to move into greater axial compression. As a result of this movement, the open end portion 110 of the end support 108 moves downwardly into contact with the suction cup 116 near its perimeter, while the driving rod 128 pulls upwardly on a central portion of the cup 116. Because of the vacuum created beneath each suction cup 116 (i.e., due to the trapped air between the cup 116 and the engaged surface), the driving rod 128 is inhibited from pulling the cup 116 out of engagement with the surface. Additionally, the contact provided by the open end portion 110 of the end support 108 inhibits the suction cup 116 peeling away from the engaged surface around the perimeter edge of the respective cup 116. To disengage the gripping device 100, the user simply rotates the cam bodies 124 in the opposite direction back to the disengaged position shown in FIGS. 1A, 2A and 3A, and can peel away the suctions cups 116 from the engaged surface around the perimeter edges of the cups 116.

Therefore, embodiments of the handheld gripping device of the present invention enable a user to easily reposition a point of stability as need when maneuvering in various indoor situations. Since certain changes may be made in the above invention without departing from the scope hereof, it is intended that all matter contained in the above description or shown in the accompanying drawing be interpreted as illustrative and not in a limiting sense.

What is claimed is:

1. A repositionable, handheld gripping device, comprising:
a handle portion;
a base from which the handle portion extends;
one or more suction elements positioned relative to the base; and
a cam driven mechanism coupled with each suction element and with the base to selectively draw the respective suction element towards and away from the base.

2. A repositionable, handheld gripping device, comprising:
a handle portion;
a pair of downwardly oriented end supports disposed at opposite sides of the handle;
a pair of suction elements; and
a pair of cam driven mechanisms, each cam driven mechanism coupled with one of the end supports of the pair of end supports and connected to one of the suction elements of the pair of suction elements, whereby movement of one of the cam driven mechanisms selectively draws the respective suction element towards and away from one of the pair of end supports.
